(19) United States
(12) Patent Application Publication
(10) Pub. No.: US 2009/0173775 A1
(43) Pub. Date: Jul. 9, 2009

(54) Disposable pressware prepared from paperboard sized with nano starch

(75) Inventors: Dean P. Swoboda, De Pere, WI (US); Greg A. Wendt, Neenah, WI (US)

Correspondence Address: PATENT GROUP GA030-43;Georgia-Pacific LLC, 133 PEACHTREE STREET, N.E., ATLANTA, GA, 30303-1847, US

(73) Assignee: Dixie Consumer Products LLC, Atlanta, GA (US)

(21) Appl. No.: 12/319,218

(22) Filed: Jan. 2, 2009

Related U.S. Application Data
(60) Provisional application No. 61/009,996, filed on Jan. 4, 2008.

(51) Int. Cl. A47G 19/03; B31B 1/44

(52) U.S. Cl. 229/407; 493/152; 493/167; 493/175; 162/175

(57) ABSTRACT

A disposable servingware container press-formed from a generally planar paperboard blank includes: (a) a bottom panel; (b) a first annular transition portion extending upwardly and outwardly from the bottom panel defining a first radius of curvature; (c) an optional sidewall portion extending upwardly and outwardly from the first annular transition portion; (d) a second annular transition portion flaring outwardly with respect to the first annular transition portion; and (e) an outer flange portion extending outwardly with respect to the second annular transition portion. The paperboard blank is generally sized with nano starch in an amount of greater than 20 lbs per 3000 ft² ream and preferably exhibits a starch layer concentration of greater than about 1.7 lbs/ream/mil.

### CLAIM FOR PRIORITY

This non-provisional application is based upon U.S. Provisional Patent Application Ser. No. 61/009,996, of the same title, filed Jan. 4, 2008. The priority of U.S. Provisional Patent Application Ser. No. 61/009,996 is hereby claimed and the disclosure thereof is incorporated into this application by reference.

### TECHNICAL FIELD

The present invention relates to disposable pressware generally and more particularly to disposable pressware sized with nano starch, preferably in an amount greater than 20 lbs per 3,000 square foot ream prior to being formed into a container.

### BACKGROUND

Disposable servingware prepared from paperboard blanks are known in the art. There is disclosed, for example, a rigid paperboard container in U.S. Pat. No. 5,326,020 to Cheshire et al. The rim of this container has a particular configuration for rigidity and strength. During fabrication, the paperboard material for forming the container is impregnated with a sizing adhesive equivalent to at least 6 pounds of starch per 3000 ft² ream of paperboard material. See also, U.S. Pat. No. 5,938,112 to Sandstrom. It is seen in FIGS. 11 and 12 of the '112 patent that plate rigidity generally increases with the amount of starch applied to the paperboard, but that very little gain in rigidity is seen above about 10 lbs of starch add-on per 3000 ft² ream when conventional starch is used. Note also, Col. 7, lines 43-48 wherein it is stated that 6-20 lbs/ream of starch can be used.

Nanoparticle starches are also known in the art. In this regard, see U.S. Pat. No. 6,755,915 to Van Soest et al. which discloses a method of preparing starch particles. The particle size of these particles is reported to be between 50 nanometers and 100 microns. The particle size is dependent on starch and cross-linking agent type, concentration, reaction time and the character of the non-solvent used during this particular method of manufacture (which is emulsion based).

Nano starches have been used as adhesives, binders, and sizing as will be appreciated from the following patents and publications. U.S. Pat. No. 7,160,420 Helbling et al. discloses starch dispersions of discreet particles of cross-linked cationic starch that can be used as a wet end additive or surface coating for paper. The starch dispersions can be prepared by: a) obtaining a mixture of cationic starch and an aqueous liquid; b) processing the mixture under shear forces in the presence of a cross-linker; and c) adding and mixing in a hydroxylic liquid to obtain the starch dispersions. U.S. Pat. No. 7,285,586 also to Helbling et al. discloses coating compositions including a pigment and a starch dispersion of cross-linked starch particles as seen in the '420 patent noted above. So also, U.S. Pat. No. 6,825,252 to Helbling et al. discloses coating compositions including a pigment, cross-linked starch particles and processing the mixture particles which may be used as a coating color for paper. Also noted is U.S. Pat. No. 7,285,586 to Helbling et al. relating to paper coatings.

Nano starch particles have also been reported to be useful as adhesives. In this regard see U.S. Pat. No. 6,921,430 to Bloembergen et al. The adhesives described in the '430 patent have starch nanoparticles having a size range up to 400 nanometers in diameter formed from a starch including greater than 95% amylopectin.

One of skill in the art will appreciate that a difficulty in using starch as an adhesive or coating composition is that relatively low solids content is typical due to the high viscosity of aqueous starch solutions. Likewise, conventional starch compositions must be dissolved at relatively high temperatures in water. One method of alleviating such problems is proposed in United States Patent Application Publication No. US 2007/0225489 (U.S. patent application Ser. No. 11/784,116). In this publication, starch is modified by chemically degrading the starch with hypochlorite or acid such that solutions can be prepared with a solids content of greater than 10%.

### SUMMARY OF THE INVENTION

It has been found in accordance with the present invention that paperboard can be sized with nano starch providing unexpectedly high concentration of starch at sized surfaces. The sized paperboard is processed into pressware containers exhibiting surprising rigidity.

In one aspect there is provided a disposable servingware container press-formed from a generally planar paperboard blank. The container includes: (a) a bottom panel; (b) a first annular transition portion extending upwardly and outwardly from the bottom panel defining a first radius of curvature; (c) an optional sidewall portion extending upwardly and outwardly from the first annular transition portion; (d) a second annular transition portion flaring outwardly with respect to the first annular transition portion; and (e) an outer flange portion extending outwardly with respect to the second annular transition portion. The paperboard blank is sized with nano starch in an amount of greater than 20 lbs per 3000 ft² ream and preferably exhibits a starch layer concentration (sometimes referred to as size press concentration) of greater than about 1.7 lbs/ream/mil. The rigidity increase seen with nano starch sizing in excess of 20 lbs per 3000 ft² ream is surprising in view of the prior art, notably U.S. Pat. No. 5,938,112, which shows diminishing stiffness gains as increased amounts of starch are added to paperboard prior to forming.

### BRIEF DESCRIPTION OF THE DRAWINGS

The invention is described in detail below with reference to the various Figures, wherein like numerals designate similar parts and wherein:

FIG. 1 is a photomicrograph of unsized paperboard;

FIG. 2 is a photomicrograph of paperboard sized with 25 lbs/3000 ft² ream of nano starch;

FIG. 3 is a photomicrograph of paperboard sized with 10 lbs/3000 ft² ream of conventional starch;

FIG. 4 is a plot of Brookfield viscosity, CPS v. size press of solution solids in percent;

FIG. 5 is a plot of size press pickup, lbs/ream v. size press solution solids;

FIG. 6 is a plot of moisture to evaporate, lbs/ream v. size press pickup, lbs/ream;

FIG. 7 is a photomicrograph illustrating penetration of nano starch into a paperboard web;

FIG. 8 is another photomicrograph illustrating penetration of nano starch into a paperboard web;

FIG. 9 is a photomicrograph illustrating penetration of conventional starch into a paperboard web;

FIG. 10 is another photomicrograph illustrating penetration of conventional starch into a paperboard web;

FIG. 11 is a plot of size press penetration, mils, v. size press solids, %;

FIG. 12 is a plot of size press concentration, lbs/ream/mil v. size press solids, %;

FIG. 13 is a plot of flexural modulus, psi×10⁻³ v. size press coat weight, lbs/ream;

FIG. 14 is a plot of tensile modulus, psi×10⁻³ v. size press coat weight, lbs/ream;

FIG. 15A is a view in perspective of a plate configured in accordance with the present invention;

FIG. 15B is a partial view in perspective and section illustrating the geometry of the plate of FIG. 15A;

FIG. 15C is a plan view showing the plate of FIG. 15A and FIG. 15B;

FIG. 15D is a view in section and elevation of the plate of FIGS. 15A-15C along line D′, D′ of FIG. 15C;

FIG. 15E is an enlarged detail illustrating the geometry of the disposable plate of FIGS. 15A-15D;

FIG. 15F is a diagram showing the profile from center of the plate of FIGS. 15A-15E;

FIG. 15G is a schematic diagram illustrating the nomenclature for various dimensions of the plate of FIGS. 15-15F;

FIG. 15H is another schematic diagram illustrating various features of the plate of FIGS. 15A-15G;

FIG. 16 is a schematic diagram illustrating a portion of an apparatus for determining Rim Stiffness;

FIG. 17A is a schematic diagram illustrating an apparatus used for measuring load-bearing capability of disposable plates;

FIG. 17B is a schematic diagram illustrating testing of load-bearing capability of a plate utilizing the apparatus of FIG. 17A;

FIGS. 18 through 20 are schematic diagrams illustrating scoring and pleating paperboard;

FIG. 21 is a schematic diagram of a paperboard blank which is scored with 40 scores of uniform spacing; and

FIGS. 22, 23, 24, 25 and 26 are diagrams illustrating a pressware die set useful for forming containers having the Profile 1 shape and its operation.

### DETAILED DESCRIPTION

The invention is described in detail below with reference to numerous embodiments for purposes of exemplification and illustration only. Modifications to particular embodiments within the spirit and scope of the present invention, set forth in the appended claims, will be readily apparent to those of skill in the art.

As used herein, terminology is given its ordinary meaning unless a more specific definition is given or the context indicates otherwise. Disposable containers of the present invention generally have a characteristic diameter. For circular bowls, plates, platters and the like, the characteristic diameter is simply the outer diameter of the product. For other shapes, an average diameter can be used; for example, the arithmetic average of the major and minor axes could be used for elliptical shapes, whereas the average length of the sides of a rectangular shape is used as the characteristic diameter and so forth. Sheet or paperboard stock refers to both a web or roll of material and to material that is cut into sheet form for processing. Unless otherwise indicated, “mil”, “mils” and like terminology refers to thousandths of an inch and dimensions appear in inches. Likewise, caliper is the thickness of material and is expressed in mils unless otherwise specified. Viscosity is reported in “cps” referring to centipoise.

Basis weight is expressed in lbs per 3000 square foot ream.

A “characteristic particle size range” refers to a particle size range wherein at least 85% by weight of the particles are of a size within that range.

Dimensions, radii of curvature, angles and so forth are measured by using conventional techniques such as laser techniques or using mechanical gauges including gauges of curvature as well as by other suitable technique. While a particular arcuate section of a container may have a shape which is not perfectly arcuate in radial profile, perhaps having some other generally bowed shape either by design or due to off-center forming, or due to relaxation or springback of the formed paperboard, an average radius approximating a circular shape is used for purposes of determining radii such as R1, R2 or R0, for example. A radius of curvature may be used to characterize any generally bowed shape, whether the shape is arcuate or contains arcuate and linear segments or comprises a shape made up of joined linear segments in an overall curved configuration. In cases where directional variation around the container exists, average values are measured in a machine direction (MD1) of the paperboard, at 90° thereto, the cross-machine direction (CD1) of the paperboard as well as at 180° to MD1 and 180° to CD1. The four values are then averaged to determine the dimension or quantity.

While the distinction between a pressware “bowl” and “plate” is sometimes less than clear, especially in the case of “deep dish” containers, a bowl generally has a height to diameter ratio of 0.15 or greater, while a plate has a height to diameter ratio of less than 0.1 in most cases. A “platter” is a large shallow plate and may be oval or any shape other than round.

“Evert”, “annular evert”, “evert portion” and like terminology refers to an outwardly extending part of the inventive containers, the evert typically occurring at the outer flange of a container adjoining a transition from a downwardly sloping brim portion of the container.

“Forming efficiency” of containers formed as described herein means the ratio between the actual strength of the container and the calculated strength that a pleatless plate, or a plate with perfectly bonded pleats, having the physical properties of the unsized board, would have as calculated by finite element analysis.

“Ream” means 3000 ft² ream unless otherwise indicated.

“Rigidity” refers to SSI rigidity in grams at 0.5″ deflection as hereinafter described.

“Rim Stiffness” refers to the Rim Stiffness in grams at 0.1″ deflection as further discussed below.

“Sizing conditions” refer to the temperature and concentration of the starch dispersion during sizing of paperboard.

“Starch Layer Concentration” refers to the amount of starch added to the paperboard divided by the surface penetration into the paperboard.

Disposable servingware containers such as pressware paperboard containers typically are in the form of plates, both compartmented and non-compartmented, as well as bowls, trays, and platters. The products are typically round or oval in shape but can also be multi-sided, for example, hexagonal or octagonal.

“Nano starch” refers to starch with a particle size distribution including small particles such that a significant proportion of the starch particles have a particle diameter of less than 1 micron. The starch is suitably prepared in accordance with U.S. Pat. No. 6,755,915 to Van Soest et al., the disclosure of which is incorporated herein by reference. If necessary, further details may be found in U.S. Pat. Nos. 7,160,420; 7,285,586; 6,825,252; as well as U.S. Pat. No. 7,285,586, all to Helbling et al., the disclosures of which are incorporated herein by reference. The starting material is preferably a native starch but previously modified starch derivatives may be used as well. Preferred sources of native starch are corn, wheat, rice, potato, tapioca and barley. The starch can be waxy starch. Starch derivatives which can be used are e.g. cationic and anionic starches carboxylated starches, carboxy methylated starches, sulfated starches, phosphated starches, starch ethers like hydroxyl alkylated starches, e.g. hydroxy ethylated and hydroxy propylated starches, oxidized starches containing carboxy or dialdehyde groups or hydrophobized starches like acetate esters, succinate ester, half-esters or phosphate esters and the like. In the process of preparing the starch dispersion starch granules or pregelatinized starch can be used as preferred starting material. The particle size of the nano starch particles used in accordance with the present invention is typically between 50 nanometers and 100 microns. A weight average particle size of from 75 nanometers to 1 micron is suitable. The particle size depends upon how the starch is prepared including the process conditions and the various components employed in the process. Generally speaking the nano starch used has an effective surface area of greater than 100 m^{2/}g and typically greater than 200 m^{2/}g, up to 1000 m^{2/}g material may be available.

Cationic starches include tertiary aminoalkyl ethers, quaternary ammonium ethers, aminoethylated starches, cyanamide derivatives, starch anthranilates and cationic dialdehyde starch, although the last three are less typical. These cationic derivatives are produced by standard reactions well known in the art. Typically cationic starches are supplied as free flowing white powder and the number of cationic groups generally range from about 2 per 100 starch monomers up to about 10. The number of cationic groups per 100 starch monomers is called a degree of substitution and is expressed as a decimal fraction. Typically most cationic starches have a degree of substitution between about 0.03 and about 0.06.

The nano starch employed may be cross-linked or uncross-linked starch. If a cross-linked starch is used, preferably 5 to 1000 mmol, more preferably 20-500 mmol, cross-linking agent is used per mol anhydroglucose unit.

Cross-linking agents which can be used are the most common bifunctional or multifunctional reagents. Examples of cross-linking agents are the common cross-linking agents such as epichlorohydrin, glyoxal, trisodium trimetaphosphate, phosphoryl chloride or an anhydride of a dibasic or polybasic carboxylic acid. The use of a phosphate, such as trisodium trimetaphosphate, as a cross-linking agent is sometimes preferred. In these cases the catalyst can be a base such as sodium hydroxide. A variety of other cross-linking agents are possible when modified starches are used. In the case of dialdehyde-starch the cross-linking agent can be, for example, a diamine or diamide, such as urea, tetramethylenediamine or hexamethylenediamine, in which case an acid can be used as a catalyst. Cross-linking can also be carried out using a diamine or a diol in the case of, for example, carboxymethylstarch or dicarboxystarch. However, here cross-linking can also, and advantageously, be achieved by internal ester formation, which can be catalyzed by a multivalent metal ion such as calcium, magnesium, aluminium, zinc or iron, preferably calcium. Another possible starting material is cationic or aminoalkyl starch, which can be cross-linked in situ using a dicarboxylic acid or a dialdehyde. A few other cross-linking agents are: functional epoxides such as diepoxybutane, diglycidyl ether and alkylene bisglycidyl ethers, dichlorohydrin, dibromohydrin, adipic anhydride, glutaraldehyde, amino acids and borax. In a number of cases it is also possible to allow a chemical modification of the starch, for example, a carboxymethylation or cationization reaction, to take place simultaneously during the cross-linking reaction.

Typically, suitable nano starches exhibit a Brookfield viscosity of less than 700 cps at 130° F. or 140° F. and 30% concentration by weight in water.

### PaperBoard Preparation

Paperboard was sized with ECOSYNTHETIX™92202 nano starch and tested for size penetration and loading. Specifically, solutions of current and nano starches were applied on a coater at various solid levels. The board samples were evaluated for stiffness properties that pertain to container rigidity. ECOSYNTHETIX™92202 nano starch is supplied in a tan granular form with a distinct odor. The granules were added to agitated warm water which is held at a temperature of 90-120° F. As the granules were added to the water slurry a weak solution (1N) of NaOH was added to maintain the pH at the recommended level of 8-9 and to prevent viscosity from increasing significantly. The solution color was a light amber. At 30% solids, the slurry became difficult to mix due to high viscosity and contained high amount of entrained air. A defoamer may be added if solids greater than about 25% by weight of the solution are used.

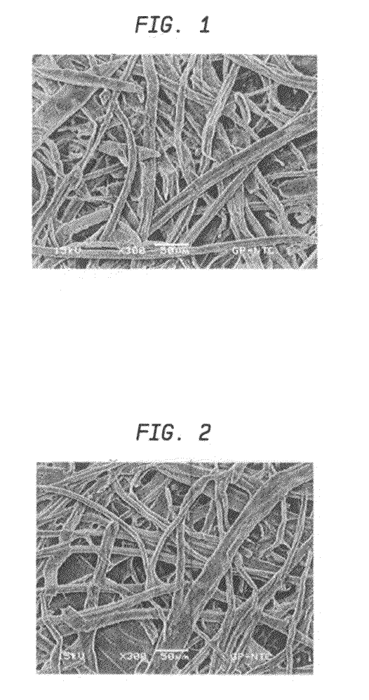

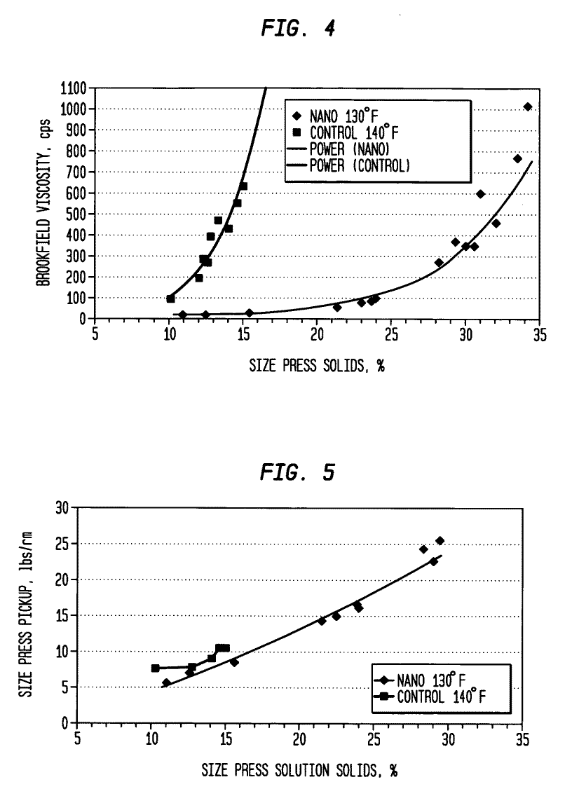

For purposes of comparison, Archer Daniels Clinton 444 control starch in powder form was added to ambient water and mixed well until homogeneous, and cooked at 190° F. for 30 minutes and then cooled to 140° F. before application. FIGS. 1-3 illustrate that there are no physical differences in how the starches coat the fiber surfaces of the board. The nano starch dried relatively clear despite its solution color. FIG. 4 is a plot of Brookfield viscosity, cps v. Size Press Solution Solids in percent. It is seen in FIG. 4 that the nano starch was 15% or greater more solids at parity viscosity levels as compared with a conventional starch. Viscosities were all measured at approximately 140° F. using a #3 spindle at 20 rpm.

FIG. 5 is plot of Size Press Pickup, lbs/ream v. Size Press Solution Solids in %. Here it is seen that it is possible to provide in excess of 20 lbs/ream of starch when the nano starch is used; however these levels are not achieved with conventional starch.

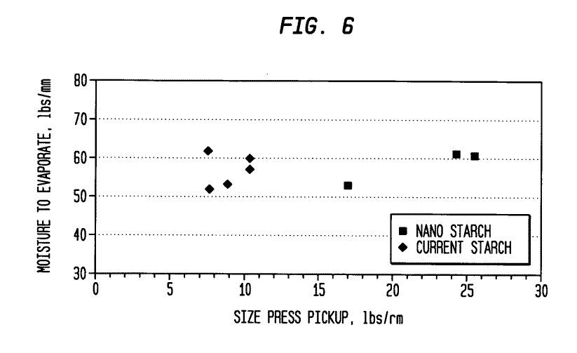

FIG. 6 is a plot of moisture to evaporate, lbs/ream v. Size Press Pickup, lbs/ream. FIG. 6 illustrates a theoretical calculation of the water that would be required to dry in the Size Press dryer section based on applied solids and size press coatweight. The nano starch and conventional starches should dry comparably and not affect board machine productivity based on the pilot results.

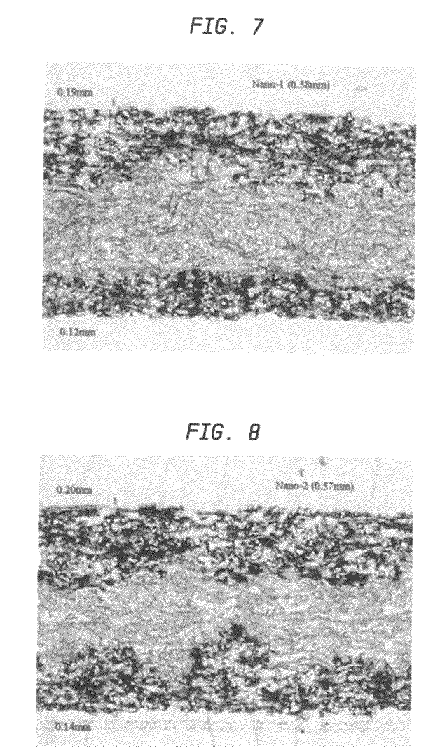

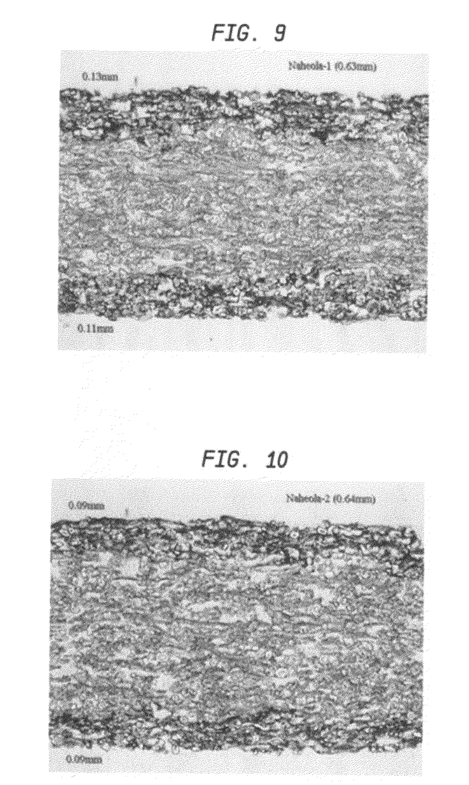

FIGS. 7 to 10 are photomicrographs which show the penetration of starch into the web. FIGS. 7 and 8 are photographs of nano starch penetration, while FIGS. 9 and 10 are photomicrographs showing the penetration of conventional starch under like conditions.

FIG. 11 is a plot of Size Press Layer Penetration, in mils v. Size Press Solids in %.

Size press layer penetration, or surface penetration is measured by examining sized paperboard specimens in cross section. One preferred technique is to place one electronic “line” generated by a microscope camera at the board surface and another electronic “line” generated by the camera at the average penetration depth. Since the penetration is not precisely uniform, the line at the penetration depth is placed such that approximately equal sized and unsized areas appear above and below the line. See FIGS. 7-10. An alternative technique, which provides substantially the same results, is to print SEM photographs of samples in section and measure penetration depth at 10 or more evenly spaced intervals.

The starch layer concentration is calculated by dividing the starch add-on by the surface penetration.

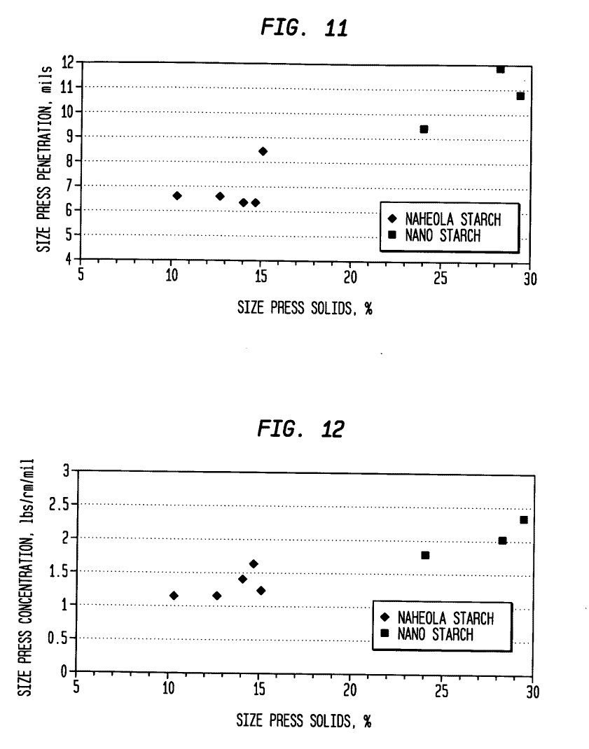

FIG. 12 is a plot of Size Press Concentration, lbs/ream/mil.

It is seen from FIGS. 11 and 12 that the nano starch not only has a deeper penetration into the board, but also that the starch layer is more concentrated; this was an unexpected result which is extremely useful in producing plates, bowls and the like with elevated rigidity as is seen from the physical property data on the paper plates produced in accordance with the invention.

FIG. 13 is a plot of Flexural Modulus, psi×10⁻³ v. Size Press Coatweight, lbs/ream.

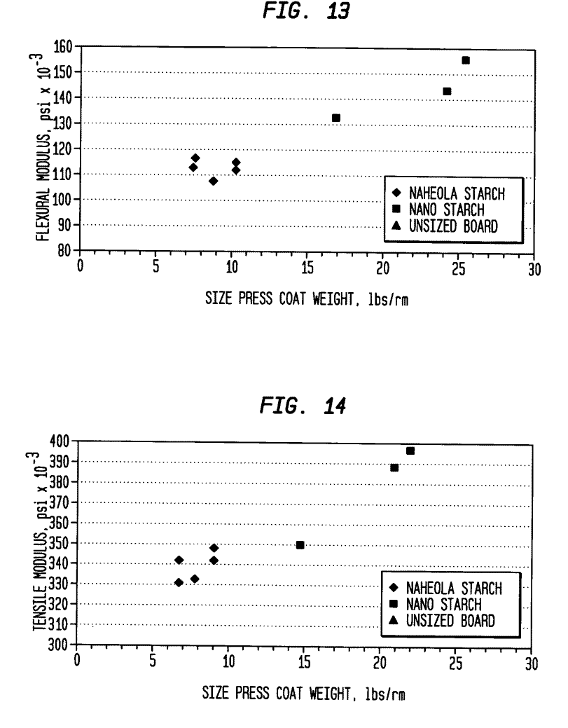

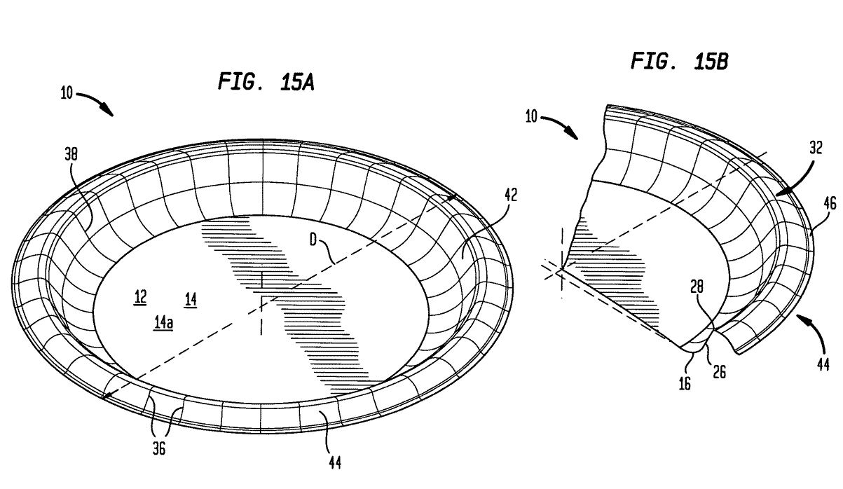

FIG. 14 is a plot of Tensile Modulus, psi×10⁻³ v. Size Press Coatweight, lbs/ream.

It is seen in FIGS. 13 and 14 that the nano starch impregnated board exhibits much higher tensile and flexural modulus values than board impregnated with conventional starch.

The estimated stiffness improvement impact on plate rigidity was calculated using FEA analysis based on a 9″ plate having the design referred to as Profile 1 below using a mathematical model. SSI plate rigidity is mathematically modeled as:

SSI Rigidity Estimate=0.00182×% Forming Efficiency×Tensile Stiffness^{0.69}×Taber Stiffness^{0.31}

where forming efficiency is calculated as:

Forming Efficiency=47.0347+(8.9927×size press weight)+(0.591 ×size press weight)+(0.0138×size press weight)

Although the two higher nano size press weights exceed model capabilities, the potential for significant rigidity improvement >100 grams is shown. It will be seen from the data hereinafter, that the mathematical model accurately estimate the rigidity for unsized plates and plates made with conventional starch.

TABLE 1
Forming Efficiency and Rigidity

| | Size Press Weight, | | Plate Rigidity, |
|---|---|---|---|
| Starch | lbs/ream | Forming Efficiency % | gms |
| Unsized | 0 | 47 | 191 |
| Nano | 25.4 | 126 | 694 |
| Nano | 24.2 | 119 | 650 |
| Nano | 16.9 | 98 | 495 |
| Control | 10.3 | 92 | 440 |
| Control | 10.3 | 92 | 444 |
| Control | 8.8 | 90 | 412 |
| Control | 7.6 | 87 | 407 |
| Control | 7.5 | 87 | 397 |

Tables 2 and 3 document tested properties of paperboard. Increased nano starch penetration contributed to a slight increase in ZDT fiber bond. The color results support observation that the nano starch dries mostly clear with a slightly brown tint. A lower ISO “L” value creates a slightly darker tint moving away from pure white (100) towards black (0). A lower ISO “a” favors a green shade moving away from red. A higher ISO “b” tends toward yellow moving away from blue. In any event the board is typically clay coated prior to forming into pressware containers.

TABLE 2
Sized Paperboard Properties

| | Basis | | Size Press | | Air | ZDT | | | |
|---|---|---|---|---|---|---|---|---|---|
| | Weight | Caliper | Weight | Sheffield | Resistances/ | Fiberbond | ISO L | ISO a | ISO b |
| Starch | Lbs/rm | mils | Lbs/rm | Roughness | 100 cm\hat{ }3 | psi | color units | color units | color units |
| Nano | 216 | 21.6 | 25.4 | 400 | 14.1 | 54 | 89.8 | −1.05 | 6.3 |
| Nano | 216 | 22.2 | 24.2 | 400 | 13.0 | 53 | 89.6 | −1.11 | 6.6 |
| Nano | 209 | 22.4 | 16.9 | 400 | 11.1 | 50 | 90.6 | −1.09 | 5.8 |
| Control | 196 | 22.8 | 10.3 | 400 | 15.7 | 44 | 91.4 | −0.95 | 4.0 |
| Control | 196 | 22.7 | 10.3 | 400 | 14.8 | 46 | 91.5 | −0.96 | 4.0 |
| Control | 164 | 22.3 | 8.8 | 400 | 14.2 | 45 | 91.4 | −0.93 | 3.9 |
| Control | 193 | 22.2 | 7.6 | 400 | 11.7 | 46 | 92.0 | −0.99 | 3.9 |
| Control | 193 | 22.3 | 7.5 | 400 | 11.5 | 45 | 92.2 | −0.96 | 3.8 |
| Control | 186 | 22.1 | 0 | 400 | 7.0 | 40 | 92.3 | −0.89 | 3.4 |
| (Unsized) | | | | | | | | | |

TABLE 3
Sized Paperboard Properties

| | Taber | Taber | Taber | | | Tensile | Tensile | Tensile |
|---|---|---|---|---|---|---|---|---|
| | Stiffness | Stiffness | Stiffness | Stretch % | Stretch % | Modulus | Modulus | Modulus |
| Starch | MD | CD | GM | MD | CD | MD | CD | GM |
| Nano | 411 | 193 | 282 | 2.7 | 5.9 | 575 | 274 | 397 |
| Nano | 410 | 196 | 284 | 2.7 | 5.9 | 556 | 271 | 388 |
| Nano | 395 | 182 | 268 | 2.5 | 5.8 | 485 | 253 | 350 |
| Control | 357 | 157 | 237 | 2.2 | 5.1 | 513 | 229 | 342 |
| Control | 369 | 158 | 241 | 2.1 | 4.7 | 524 | 227 | 349 |
| Control | 355 | 152 | 232 | 2.1 | 4.7 | 497 | 222 | 332 |
| Control | 350 | 147 | 227 | 2.0 | 4.4 | 505 | 231 | 342 |
| Control | 358 | 151 | 232 | 2.1 | 4.5 | 487 | 224 | 330 |
| Control | 288 | 114 | 181 | 1.4 | 3.3 | 495 | 206 | 319 |
| (Unsized) | | | | | | | | |

It is seen from the foregoing that using nano starch makes it possible to apply more starch weight and create greater board stiffness. It will be seen later that although the paperboard stiffness is increased moderately, the very large increases observed in pressware stiffness is surprising.

Utilizing the procedures noted generally above, EcoSynthetix™ 92202 nano starch was tested on a commercial board machine to produce board for subsequent plate forming. The material was prepared in aqueous solution at 30% solids, a pH of about 7, having a viscosity of 500 cps at 70° F. At higher temperatures, the viscosity was lower, for example, at 110° F. the viscosity was 250 cps; at 130° F. the viscosity was 80 cps and at 150° F. the viscosity of the solution was 50 cps. The nano trial starch was blended gradually into the size press solution at the nip with the current starch while the machine continued to run. Subsequently, the paperboard was clay-coated. After equilibration, calendar stack moisture increased and stabilized at 3.9%. Machine speed (about 700 fpm) was not adjusted. Size press add-on increased from 13 to 30 lbs/ream. Reel basis weight increased from 230 to 247 lbs/ream. Samples were tested and the results appear in Tables 4, 5 and 6 below.

TABLE 4
Board Physical Properties

| | Basis | | Gloss | | ZDT | Parker | | | | |
|---|---|---|---|---|---|---|---|---|---|---|
| | Weight | Caliper | 60 | Sheffld | Fiber | Print | Taber | Taber | Tensile | Tensile |
| Strach | lbs/ream | mils | deg | Rough U | bond | S1000 | md | cd | md | md |
| Control | 231 | 20.0 | 10.8 | 274 | 48 | 1.50 | 347 | 162 | 134 | 65 |
| Nano | 247 | 20.7 | 11.2 | 309 | 50 | 1.72 | 391 | 177 | 152 | 75 |

TABLE 5
Board Color

| | | | Color | | Color | Color | Color | Color | |
|---|---|---|---|---|---|---|---|---|---|
| | Stretch | Stretch | Ctd Side | Color Ctd | Unctd Side | Unctd Side | Unctd Side | Unctd Side | Dry warp |
| Strach | Md % | Cd % | ISO L | Side ISO a | ISO b | ISO L | ISO a | ISO b | deg |
| Control | 2.88 | 5.61 | 90.91 | −0.81 | 3.40 | 91.50 | −0.61 | 2.54 | 4.3 |
| Nano | 3.15 | 6.06 | 89.32 | −0.58 | 3.81 | 88.80 | −0.55 | 4.47 | 0.6 |

TABLE 6
Starch Penetration

| | Analytical | | | Starch | Starch |
|---|---|---|---|---|---|
| | Starch | | Coating | Top Side | Top Side |
| | Pickup | Coating Clay | CaCO3 | Penetration | Penetration |
| Starch | Lbs/rm | Lbs/rm | Lbs/rm | mm | mm |
| Control | 14.0 | 6.6 | 3.5 | .14 | .16 |
| Nano | 27.3 | 6.8 | 3.6 | .16 | .18 |

The starch composition used to impregnate the paperboard optionally includes suitable nano pigments as well. As noted in U.S. Pat. No. 5,938,112 to Sandstrom, the amount and type of pigment must be judiciously selected so as not to adversely impact board and container properties, nor interfere with processability. Suitable nano pigments may be selected from titanium dioxide, talc, mica, kaolin, calcium carbonate, alumina, zinc oxide, and mixtures of these materials. With respect to additional materials which may be suitable, note U.S. Pat. No. 6,919,111 to Swoboda et al., the disclosure of which is incorporated by reference.

After being impregnated with starch, the paperboard is typically coated on one side with a liquid proof layer or layers comprising a press-applied, water-based coating applied over the inorganic pigment typically applied to the board during manufacturing. Carboxylated styrene-butadiene resins may be used with or without filler if so desired. In addition, for esthetic reasons, the paperboard stock is often initially printed before being coated with an overcoat layer. As an example of typical coating material, a first layer of latex coating may be applied over the printed paperboard with a second layer of acrylic coating applied over the first layer. These coatings may be applied either using the conventional printing press used to apply the decorative printing or may be applied using some other form of a conventional press coater. Preferred coatings utilized in connection with the invention may include 2 pigment (clay) containing layers, with a binder, of about 6 lbs/3000 ft² ream or so followed by 2 acrylic layers of about 0.5-1 lbs/3000 ft² ream. The clay containing layers are provided first during board manufacture and the acrylic layers are then applied by press coating methods, i.e., gravure, coil coating, flexographic methods and so forth as opposed to extrusion or film laminating methods which are expensive and may require off-line processing as well as large amounts of coating material. An extruded film, for example, may require 25 lbs/3000 ft² ream. One preferred coating system is described in U.S. Pat. No. 6,893,693 to Swoboda et al. entitled “High Gloss Disposable Pressware”, the disclosure of which is incorporated herein by reference.

After coating, the paperboard is cut into blanks and processed into pressware having a shape, for example, as described below as Profile 1. Further details are seen in copending U.S. patent application Ser. No. 12/259,487, filed Oct. 28, 2008 (Attorney Docket No. 20417; GP-07-12), the disclosure of which is incorporated herein by reference. Other suitable shapes are described in U.S. Pat. No. 5,088,640 to Littlejohn; U.S. Pat. No. 5,326,020 to Chesire et al.; U.S. Pat. No. 6,715,630 to Littlejohn et al.; and United States Patent Application Publication No. US 2006/0208054 of Littlejohn et al., the disclosures of which are incorporated herein by reference in their entirety.

### Profile 1

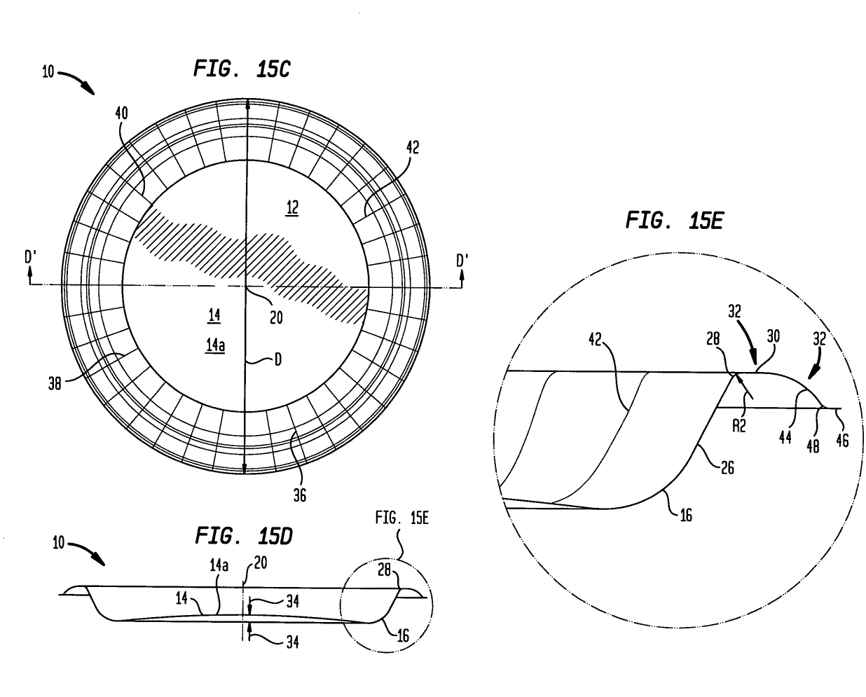

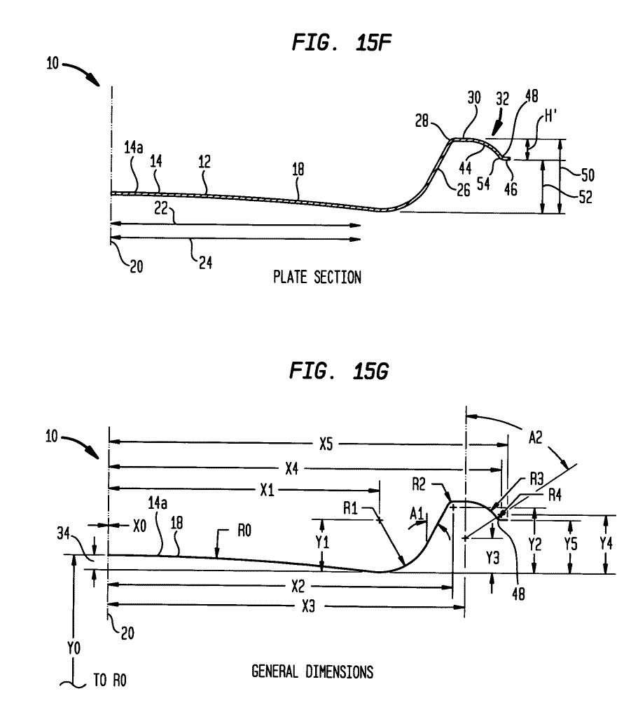

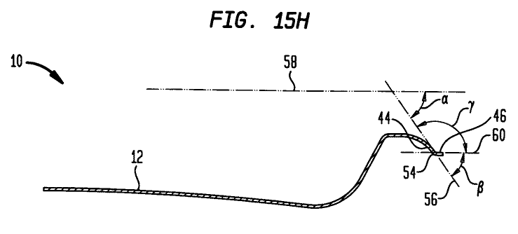

There are shown in FIGS. 15A through 15H various illustrations of a disposable container produced with a nano starch sized paperboard blank having the shape designated herein as Profile 1. A disposable food container in the form of a plate 10 has a characteristic diameter, D, a bottom panel 12 having an arched central crown 14 with a convex upper surface 14a as well as a first annular transition portion 16 which extends upwardly and outwardly from bottom panel 12. Upper surface 14a of arched central crown 14 defines a substantially continuous, convex arched profile 18 extending from a center 20 of container 10 toward first annular transition portion 16 for the (horizontal) distance 22 which is at least 75% of a horizontal distance 24 between center 20 of container 10 and first annular transition portion 16. In the various embodiments shown, the highest point of arched central crown 14 is shown at center 20. While this is typically a preferred geometry, the highest point of the arched crown may occur off-center due to forming a blank which is not perfectly aligned in a die set, or due to relaxation or spring back or by design. A sidewall portion 26 extends upwardly and outwardly from first annular transition portion 16. A second annular transition portion 28 flares outwardly with respect to first annular transition portion 16 and defines a second radius of curvature, R2, the ratio of R2/D generally being 0.0125 or less. A generally linear inner flange portion 30 extends to an outer flange portion 32 which, in turn, extends outwardly with respect to the second annular transition portion. The upwardly convex central crown has a crown height 34 of from about 0.05″ to about 0.40″.

As will be appreciated from the various diagrams, the crown height is the maximum distance of the crown above the lowermost portion of the profile that the crown rises. Typically, the crown height is defined at the center of the container.

Plate 10 also has a plurality of pleats such as pleats 36, 38, 40 and 42 which extend from first annular transition portion 16 to the outer edge of the container. Preferably, these pleats correspond to the scores of a scored paperboard blank and include a plurality of paperboard lamellae which are reformed into a generally inseparable structure which provides strength and rigidity to the container, as discussed in more detail hereinafter.

The various structural features of the plate are particularly apparent in FIGS. 15F, 15G and 15H which are diagrams illustrating a profile from center of plate 10 having Profile 1. Bottom panel 12 has an arched central crown 14 with a convex upper surface 14a which extends from the center of the plate indicated at 20 to first annular transition portion 16. That is, the arched crown extends across the center all the way and directly adjoins first annular transition portion 16. At first annular transition portion 16, the plate flares upwardly and outwardly to sidewall portion 26 at a radius of curvature R1. Sidewall portion 26 makes an angle A1 with a vertical. At the upper portion of sidewall 26, the plate flares outwardly at second annular transition portion 28 defining a second radius of curvature R2. An outward brim section 44 flares outwardly and downwardly defining a radius of curvature R3 over angle A2 as shown in the diagram. At the outer edge of brim portion 44, the plate turns outwardly defining a radius of curvature R4. An outward evert 46 provides strength and rigidity to the container as described in United States Patent Publication No. US 2006/0208054 to Littlejohn et al. noted above.

The various dimensions in FIGS. 15F and 15G appear in Table 7, wherein: Y indicates generally a height from the lowermost portion of the bottom of the container (with the exception of Y0 which is the height of the crown from the origin of R0). Y1 is the height above the bottom of the container of the origin of radius of curvature R1 of first transition portion 16; Y2 is the height above the bottom of the container of radius of curvature R2; Y3 is the height above the bottom of the container of the origin of radius of curvature R3 of the outer portion 44 of brim 32; Y4 is the height above the bottom of the container of the origin of radius R4 of an outward transition portion 48; and Y5 is the height above the bottom of the container of evert portion 46. Similarly, X1 indicates the distance from center (X0) of the origin of radius of curvature R1. Likewise, X2 and X3 indicate respectively, the distance from the center of the plate (X0) of the origins of radii of curvature R2 and R3. Likewise, X4 indicates the distance from center of the origin radius of curvature, R4. X5 indicates the radius of the plate; that is ½ D.

Y0 is indicated schematically in the diagrams as the distance from the bottom of container center 20 to the origin of a radius of curvature R0 of convex upper surface 14a of arched central crown 14 of bottom panel 12. This aspect is a salient feature of the invention which is seen in the various examples and Tables and especially appreciated from the rigidity data, discussed below.

The height of the brim, “brim height”, “brim vertical drop” and like terminology refers to the difference H′ between the overall height of the container 50, FIG. 15F and height 52 of the periphery.

FIG. 15H illustrates the various angles α, β and γ of the embodiment of the Profile 1. Angle α is the angle between a tangent 56 at the terminus 54 of downwardly sloping brim portion 44 and a horizontal line 58. The eversion angle β is the angle between a tangent 60 to evert 46 adjacent its junction with transition 48 and tangent line 56 which is tangent to the terminus of portion 44 as shown. β is thus an outward change in downward slope of the outer portion of the article and may be measured directly or may alternatively be calculated as 180°-γ where the angle, γ, is the angle between tangent line 56 to portion 54 and tangent line 60 to evert portion 46. Angle β may be anywhere from 25° to 160° on an absolute basis. Portion 46 may have an upward slope, a downward slope or have 0 slope as is the case with Profile 1 where evert 46 is horizontal. It is not necessary that the length of the evert be uniform around the plate, nor is it required that the evert have a linear profile or a profile that is a combination of linear segments. The profile may be arcuate, for example, or comprise a combination of arcuate and linear segments as part of a generally bowed shape.

Generally, the eversion angle β is from about 30° to about 160°, more typically, from about 30° to about 120° or more preferably from about 30° to about 90° with from about 35° to about 65° or about 45° to about 55° in some particularly preferred cases. The evert portion preferably extends outwardly from the annular flange transition portion a length of at least about 0.005 D, while typically the evert portion extends outwardly from the annular flange transition portion a length of at least about 0.007 D. In many embodiments, the evert portion extends outwardly from the annular flange transition portion a length of from about 0.005 D to about 0.06 D, with a length of from about 0.007 D to about 0.03 D being a preferred range; for example, the evert portion may extend outwardly from the annular flange transition portion a length over its profile of from about 0.01 D to about 0.025 D. The evert portion may also extend upwardly, downwardly, or substantially horizontally from the brim transition portion and may have a linear profile or a curved profile and extend upwardly over a portion of its profile and downwardly over a portion of its profile. The length of the evert is measured along its profile, that is from the brim transition to the end of the evert. The height of any upward extension of the evert portion above the brim transition portion is preferably less than about 50 percent of the brim height, and is less than about 25 percent in most cases.

Still referring to FIGS. 15G and 15H, the downwardly sloping brim of the container makes a declivity angle α at its terminus with respect to a horizontal substantially parallel to the bottom portion which is generally less than about 80° or so. Less than about 75° is somewhat typical, with less than about 70° or 65° preferred in most cases. Likewise, the declivity angle α is typically at least about 25° or so, with a declivity angle α of at least 30°, 40°, 50° or between about 50° and about 60° being suitable in many embodiments. Between the downwardly sloping brim portion and the evert, the transition portion typically has a fairly small radius of curvature R4. Generally, the radius of curvature of the transition is less than ½″, typically less than about ¼″ and preferably about 1/16″ or so for plates having a diameter of 8-10″ or so. In most cases, a radius of curvature of the brim transition portion will be less than about ⅛″, such as 1/16″ or less. Radius of curvature R4 of the brim transition section will perhaps most preferably be between about ⅛″ and 1/32″. Without intending to be bound by theory, it is believed that a relatively small radius at R4 is beneficial in strengthening the rim of a pleated container to “lock” the pleated structure in place as is noted above in connection with R2. The ratio of the flange outer vertical drop or brim height, H′, to the characteristic diameter, D, is generally greater than about 0.01. Further details as to the geometry of the class shown in Profile 1 (exclusive of bottom panel configuration and R2 curvature) are provided generally in United States Patent Publication No.: US 2006/0208054 to Littlejohn et al. (U.S. patent application Ser. No. 10/963,686), the disclosure of which is incorporated herein by reference specifically with respect to such features.

TABLE 7
Die Side Profile Dimensions
(Refer to FIGS. 15A and following for appropriate shape)

| | Profile 1, | Profile 1, |
|---|---|---|
| | 10″ | 9″ |
| Shape/ | (0.188 | (0.159 |
| Size | Crown) | Crown) |
| R0 | 31.0822 | 25.4837 |
| X0 | 0.0000 | 0.0000 |
| Y0 | −30.8942 | −25.3248 |
| R1 | 0.5917 | 0.5650 |
| X1 | 3.4459 | 2.8726 |
| Y1 | 0.5917 | 0.5650 |
| R2 | 0.0740 | 0.0625 |
| X2 | 4.3252 | 3.6551 |
| Y2 | 0.8393 | 0.7093 |
| R3 | 0.4674 | 0.3950 |
| X3 | 4.4774 | 3.7837 |
| Y3 | 0.4459 | 0.3768 |
| R4 | 0.0740 | 0.0625 |
| X4 | 4.9227 | 4.1600 |
| Y4 | 0.7538 | 0.6370 |
| X5 | 4.9900 | 4.2248 |
| Y5 | 0.6798 | 0.5745 |

### Rigidity and Rim Stiffness

Plates of the invention were evaluated for SSI Rigidity and Rim Stiffness and compared with plates having a like design sized with conventional starch. Rigidity is expressed in grams/0.5″ and is measured with the Single Service Institute Plate Rigidity Tester of the type originally available through Single Service Institute, 1025 Connecticut Ave., N.W., Washington, D.C. The SSI rigidity test apparatus has been manufactured and sold through Sherwood Tool, Inc., Kensington, Conn. This test is designed to measure the rigidity (i.e., resistance to buckling and bending) of paper and plastic plates, bowls, dishes, and trays by measuring the force required to deflect the rim of these products a distance of 0.5″ while the product is supported at its geometric center. Specifically, the plate specimen is restrained by an adjustable bar on one side and is center supported. The rim or flange side opposite to the restrained side is subjected to 0.5″ deflection by means of a motorized cam assembly equipped with a load cell, and the force (grams) is recorded. The test simulates in many respects the performance of a container as it is held in the hand of a consumer, supporting the weight of the container's contents. SSI rigidity is expressed as grams per 0.5″ deflection. A higher SSI value is desirable since this indicates a more rigid product. All measurements were done at standard TAPPI conditions for paperboard testing, 72° F. and 50% relative humidity. Geometric mean averages (square root of the MD/CD product) values are reported herein.

For Wet Rigidity the specimen is conditioned as above, then filled with water at 160° F. for 30 minutes, drained and tested. For 10″ plates, 130 ml of hot water is used.

The particular apparatus employed for SSI rigidity measurements was a Model No. ML-4431-2 SSI rigidity tester as modified by Georgia-Pacific Corporation, National Quality Assurance Lab, Lehigh Valley Plant, Easton, Pa. 18040 using a Chatillon gauge available from Chatillon, Force Measurements Division, P.O. Box 35668, Greensboro, N.C. 27425-5668.

Rim Stiffness is a measure of the local rim strength about the periphery of the container as opposed to overall or SSI rigidity. This test has been noted to correlate well with actual consumers' perception of product sturdiness. SSI rigidity is one measure of the load carrying capability of the plate, whereas Rim Stiffness often relates to what a consumer feels when flexing a plate to gauge its strength. (Plates with higher Rim Stiffness have also demonstrated greatly improved weight carrying capabilities under simulated use testing, described hereinafter.) Preferably, specimens are conditioned and testing performed at standard conditions for paperboard testing when a paper container is tested, 72° F. and 50% relative humidity.

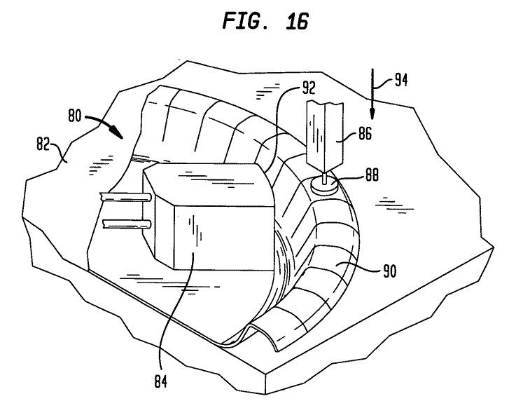

The particular apparatus employed is referred to as a Rim Stiffness instrument, developed by Georgia-Pacific, Neenah Technical Center, 1915 Marathon Avenue, Neenah, Wis. 54956. This instrument includes a micrometer which reads to 0.001″ available from Standard Gage Co., Inc., 70 Parker Avenue, Poughkeepsie, N.Y. 12601, as well as a load gauge available from Chatillon, Force Measurements Division, P.O. Box 35668, Greensboro, N.C. 27425-5688. The test procedure measures the force to deflect the rim downwardly 0.1″ as the specimen is restrained about its bottom between a platen and a restraining member as will be further appreciated by reference to FIG. 16.

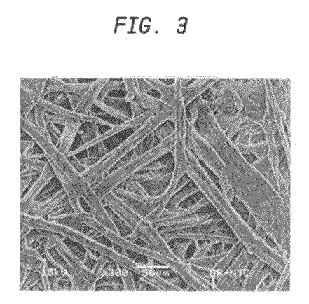

Rim Stiffness instrument 80 includes generally a platen 82, a plurality of restraining members, preferably four equally spaced restraining members such as member 84 and a gauge 86 provided with a probe 88. A specimen such as plate 90 is positioned as shown and clamped tightly about its planar bottom portion to platen 82 by way of restraining members, such as member 84. The specimen is clamped over an area of several square inches or so such that the bottom of the specimen is fully restrained inwardly from the first transition portion. Note that restraining member 84 is disposed such that its outer edge 92 is positioned at the periphery of the serving area of the container, that is, at X1 in FIG. 2G, the radius of the bottom of the container.

Probe 88 is then advanced downwardly in the direction of arrow 94 a distance of 0.1″ while the force is measured and recorded by gauge 86. Only the maximum force is recorded, typically occurring at the maximum deflection of 0.1″. Probe 88 is preferably positioned in the center of the flange of plate 90 or on a high point of the flange as appropriate. The end of the probe may be disk-shaped or of other suitable shape and is preferably mounted on a universal-type joint so that contact with the rim is maintained during testing. Probe 88 is generally radially aligned with restraining clamp member 84.

Comparisons of Rigidity and Rim Stiffness of plates of the invention with comparative plates of like design appear in Tables 3, 4 and 5, below. In some cases, finite element analysis (FEA) was used instead of actual specimens.

### Load to Failure Testing

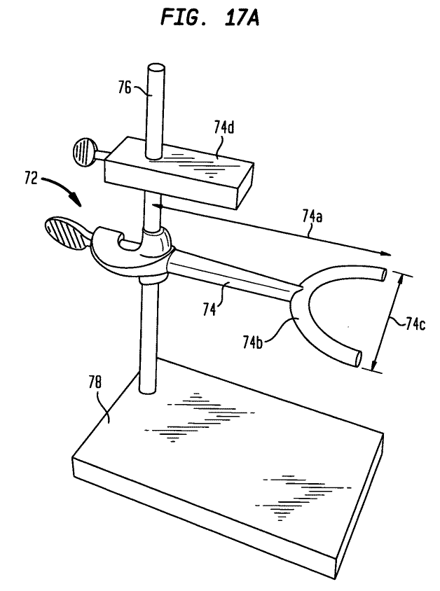

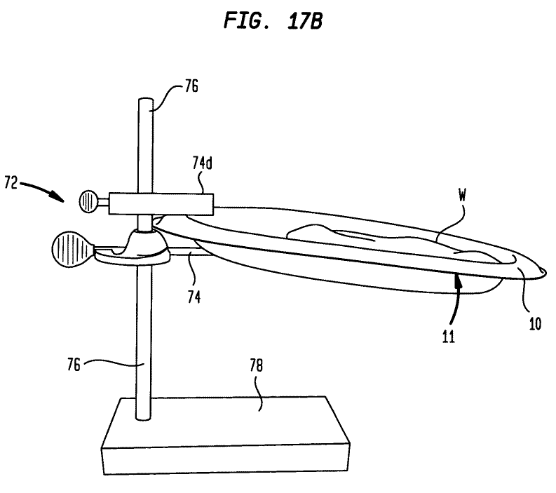

Plates of the present invention and various conventional plates were tested for their ability to support a simulated food load. Load to failure testing involved securing the plate at one side while supporting its bottom panel at center (1 hand test) and loading the plate with weights to simulate a food load until failure occurred. The load causing failure is reported as the maximum load; “failure” being determined as the point at which the plate buckled or otherwise could not support the load. The test is better understood with reference to FIGS. 17A and 17B.

The apparatus 72 used to measure load to failure includes a supporting arm 74 which is clamped to a post 76 which is mounted on a base 78 as shown in FIG. 17A. Supporting arm 74 extends outwardly a distance 74a from post 76 of about 4⅛″. The arm further defines a supporting fork 74b which has a supporting span 74c across the fork of about 2⅝″ (center to center). Further provided is a clamping member 74d used to secure a plate such as plate 10 in apparatus 72.

In FIG. 17B a plate 10 is shown mounted in apparatus 72 wherein fork 74b supports plate 10 in its central area and the plate abuts post 76. To determine load-bearing capability, weights such as weight W are used to simulate a food load on an outer portion 11 of plate 10. Weights are added in small increments (¼ lb) until the plate fails. The load just before the load causing failure (lbs) is recorded as the one hand hold maximum dry weight for this test.

While this test is somewhat more qualitative than those noted above for Rigidity, Rim Stiffness, Instron Plate Rigidity and Center Arch Stiffness, results again show that the plates of the invention are significantly stronger than plates of like basis weight of the prior art.

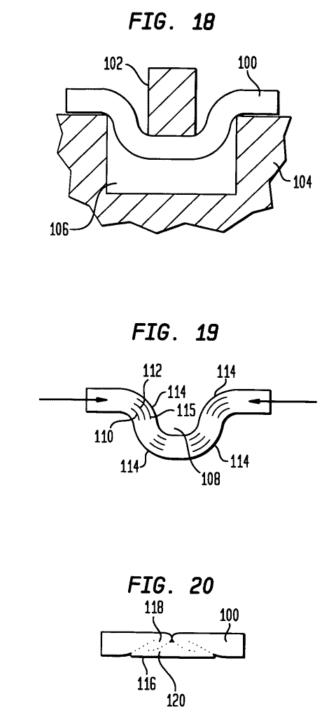

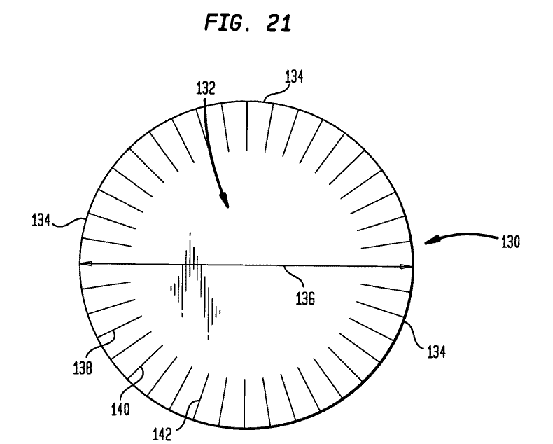

In preferred cases, the paperboard is scored prior to forming into a container to promote pleat formation. In FIG. 18 there is shown a portion of paperboard stock 100 positioned between a score rule 102 and a scoring counter 104 provided with a channel 106 as would be the case in a scoring press or scoring portion of a pressware forming press. The geometry is such that when the press proceeds reciprocally downwardly and scores blank 100, U-shaped score 108 results, see FIG. 19. At least incipient delamination of the paperboard into lamellae indicated at 110, 112, 115 is believed to occur in the sharp corner regions indicated at 114. The same reciprocal scoring operation could be performed in a separate press operation to create blanks that are fed and formed subsequently. Alternatively, a rotary scoring and blanking operation may be utilized as is known in the art. When the product is formed in a heated matched die set, preferably a generally U-shaped pleat 116 (FIG. 20) with a plurality of rebonded paperboard lamellae 118, 120 along the pleat is formed such that pleats 116 (or 36, 38, 40 and so forth as shown in FIG. 15A and following) have the configuration shown schematically. This shape may be referred to as an “omega” shape, a “horseshoe” shape or a “crushed horseshoe” shape. While the pleats will often have this structure, in other cases a Z or S shaped pleat may be formed, corresponding in essence to ½ of a U-shaped pleat.

During the forming process described hereinafter as a pleat is formed, internal delamination of the paperboard into a plurality of lamellae occurs, followed by rebonding of the lamellae under heat and pressure into a substantially integrated fibrous structure generally inseparable into its constituent lamellae. Preferably, the pleat has a thickness roughly equivalent to the circumferentially adjacent areas of the rim and most preferably is more dense than adjacent areas. Integrated structures of rebonded lamellae are indicated schematically at 118, 120 in FIG. 20 on either side of paperboard fold lines in the pleat indicated in dashed lines.

The substantially rebonded portion or portions of the pleats 116 in the finished product preferably extend generally over the entire length (75% or more) of the score which was present in the blank from which the product was made. The rebonded portion of the pleats may extend only over portions of the pleats in an annular region of the periphery of the article in order to impart strength. Such an annular region or regions may extend, for example, around the container extending approximately from the transition of the bottom of the container to the sidewall outwardly to the outer edge of the container, that is, generally along the entire length of the pleats shown in the Figures above. The rebonded structures may extend over an annular region which is less than the entire profile from the bottom of the container to its outer edge. Referring to FIG. 15E, for example, an annular region of rebonded structures oriented in a radial direction may extend around the container from inner transition 16 to the outermost edge of evert 46. Alternatively, an annular region or regions of such rebonded structures may extend over all or only a portion of the length of sidewall 26; over all or part of second annular transition portion 28; over all or part of outer flange portion 30; or combinations thereof. It is preferable that the substantially integrated rebonded fibrous structures formed extend over at least a portion of the length of the pleat, more preferably over at least 50% of the length of the pleat and most preferably over at least 75% of the length of the pleat. Substantially equivalent rebonding can also occur when pleats are formed from unscored paperboard.

At least one of the optional sidewall portion, the second annular transition portion, and the outer flange portion is provided with a plurality of circumferentially spaced, radially extending regions formed from a plurality of paperboard lamellae rebonded into substantially integrated fibrous structures generally inseparable into their constituent lamellae. The rebonded structures extend around an annular region corresponding to a part of the profile of the optional sidewall, second annular transition portion or the outer flange portion of the container. More preferably, the integrated structures extend over at least part of all of the aforesaid profile regions about the periphery of the container. Still more preferably, the integrated rebonded structures extend generally over the length of the pleats, over at least 75% of their length, for instance; however, so long as a majority of the pleats, more than about 50% for example, include the rebonded structures described herein over at least a portion of their length, a substantial benefit is realized. In some preferred embodiments, the rebonded structures define an annular rebonded array of integrated rebonded structures along the same part of the profile of the container around an annular region of the container. For example, the rebonded structures could extend along the optional sidewall portion of all of pleats shown in FIG. 15A and following along a length to define an annular array around the optional sidewall portion of the container.

A suitable paperboard blank to make the inventive containers is shown in plan view in FIG. 21. In FIG. 21 a paperboard blank 130 impregnated with nano starch is generally planar and includes a central portion 132 defining generally thereabout a perimeter 134 having a diameter 136. There is provided about the perimeter 134 of blank 130 a plurality of scores such as scores 138, 140 and 142. The scores are preferably evenly spaced and facilitate formation of evenly spaced pleats.

The following co-pending patents and patent applications contain further information as to materials, processing techniques and equipment and are also incorporated by reference: U.S. Pat. No. 7,337,943, entitled “Disposable Servingware Containers with Flange Tabs” (Attorney Docket No. 2421; GP-02-5); U.S. Pat. No. 7,048,176, entitled “Deep Dish Disposable Pressed Paperboard Container” (Attorney Docket No. 2312; FJ-00-39); U.S. Pat. No. 6,893,693, entitled “High Gloss Disposable Pressware” (Attorney Docket No. 2251; FJ-00-9); U.S. Pat. No. 6,733,852, entitled “Disposable Serving Plate With Sidewall-Engaged Sealing Cover”, (Attorney Docket No. 2242; FJ-00-32); U.S. Pat. No. 6,715,630, entitled “Disposable Food Container With A Linear Sidewall Profile and an Arcuate Outer Flange” (Attorney Docket No. 2386; GP-01-27); U.S. Pat. No. 6,474,497, entitled “Smooth Profiled Food Service Article” (Attorney Docket No. 2200; FJ-99-11); U.S. Pat. No. 6,592,357, entitled “Rotating Inertial Pin Blank Stops for Pressware Die Set” (Attorney Docket 2222; FJ-99-23); U.S. Pat. No. 6,589,043, entitled “Punch Stripper Ring Knock-Out for Pressware Die Sets” (Attorney Docket No. 2225; FJ-99-24); U.S. Pat. No. 6,585,506, entitled “Side Mounted Temperature Probe for Pressware Die Set” (Attorney Docket 2221; FJ-99-22); U.S. application Ser. No. 11/465,694 (Publication No. US 2007/0042072), entitled “Pressware Forming Apparatus, Components Therefore and Methods of Making Pressware Therefrom” (Attorney Docket 20045-US), now U.S. Pat. No. ______. See also, U.S. Pat. No. 5,249,946; U.S. Pat. No. 4,832,676; U.S. Pat. No. 4,721,500; and U.S. Pat. No. 4,609,140, which are particularly pertinent.

The paperboard stock is moistened on the uncoated side after sizing and all of the printing and coating steps have been completed. In a typical forming operation, the web of paperboard stock is fed continuously from a roll through a scoring and cutting die to form the blanks which are scored and cut before being fed into position between the upper and lower die halves. The die halves are heated as described above, to aid in the forming process. It has been found that best results are obtained if the upper die half and lower die half—particularly the surfaces thereof—are maintained at a temperature in the range of from about 250° F. to about 400° F., and most preferably at about 325° F.±25° F. These die temperatures have been found to facilitate rebonding and the plastic deformation of paperboard in the rim areas if the paperboard has the preferred moisture levels. At these preferred die temperatures, the amount of heat applied to the blank is sufficient to liberate the moisture within the blank and thereby facilitate the deformation of the fibers without overheating the blank and causing blisters from liberation of steam or scorching the blank material. It is apparent that the amount of heat applied to the paperboard will vary with the amount of time that the dies dwell in a position pressing the paperboard together. The preferred die temperatures are based on the usual dwell times encountered for normal plate production speeds of 40 to 60 pressings a minute, and commensurately higher or lower temperatures in the dies would generally be required for higher or lower production speeds, respectively.

Without intending to be bound by theory, it is believed that increased moisture, temperature, and pressure in the region of the pleat during pleat formation facilitates rebonding of lamellae in the pleats; accordingly, if insufficient rebonding is experienced, it can generally be addressed by increasing one or more of temperature, pressure or moisture.

A die set wherein the upper assembly includes a segmented punch member and is also provided with a contoured upper pressure ring is advantageously employed in carrying out the present invention. Pleating control is preferably achieved in some embodiments by lightly clamping the paperboard blank about a substantial portion of its outer portion as the blank is pulled into the die set and the pleats are formed. For some shapes the sequence may differ somewhat as will be appreciated by one of skill in the art. Paperboard containers configured in accordance with the present invention are perhaps most preferably formed from scored paperboard blanks.

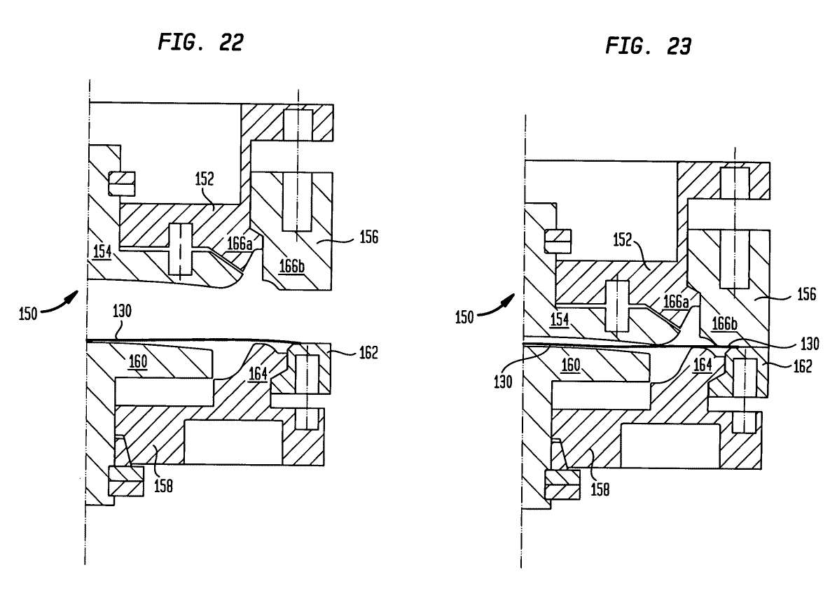

Referring to FIGS. 22 through 26 there is shown schematically from center a segmented die set 150 for making plates having the shape of Profile 1. Die set 150 includes a punch base 152, a punch knock-out 154 and a pressure ring 156. Pressure ring 156 is typically spring-biased as is well known in the art. The die set also includes a die base 158, as well as a die knock-out 160 and a draw ring 162. Draw ring 162 is likewise spring biased. The punch knock-out is sometimes an articulated style (as shown here) having 0.030″ to 0.120″ articulation stroke during the operation. The pressure ring may have the outer product profile machined into it and provides further pleating control by clamping the blank between its profile area and die outer profile during the formation as will be appreciated by one of skill in the art. Preferably, the die base 158 defines a continuous forming contour 164 as shown, while the punch forming contour may be a split contour having portions 166a, 166b as shown.

FIGS. 22-26 illustrate the sequential operation of the forming die as the product 10 of FIG. 15A is formed. In FIG. 22, the die set is fully open and receives a planar paperboard blank such as blank 130. In FIG. 23 the punch is seen to have advanced toward the die such that pressure ring 156 and draw ring 162 have advanced toward the blank and will contact the blank at its outermost portions. The punch pressure ring contacts the blank, clamping it against the lower draw ring and an optional relief area (not shown) to provide initial pleating control. The draw ring and pressure ring springs typically are chosen in a manner to allow full movement of the draw ring prior to pressure ring movement (i.e., full spring force of draw ring is less than or equal to the pre-load of the pressure ring springs). It is noted with respect to FIG. 23 that the forming contours of the bases have advanced toward blank 130, but have not yet closed thereupon.

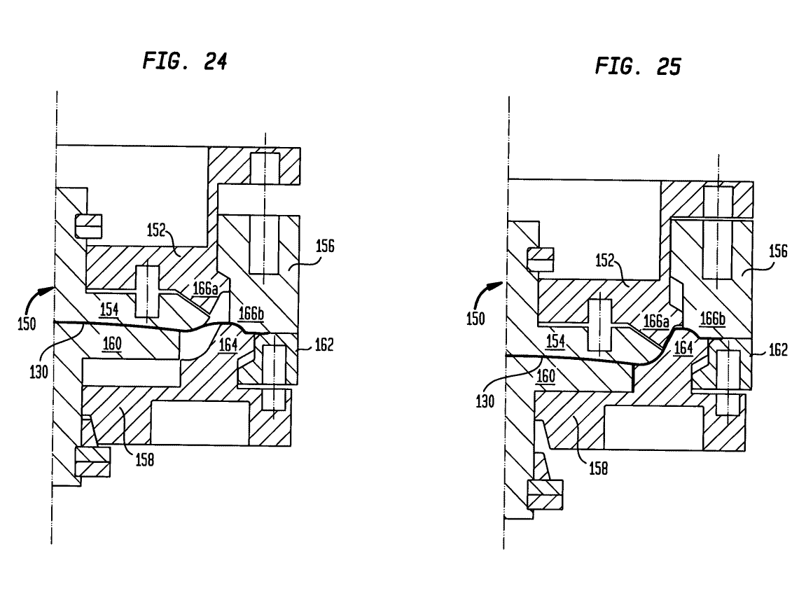

In FIG. 24, the die set continues to close, with punch base 152 continuing to advance towards die base 158, wherein the knock-outs 154, 160, forming contour 164, and forming contour portion 166b are contacting the blank. The punch and die knock-outs (which may have compartment ribs machined into them) hold the blank on center as it is formed.

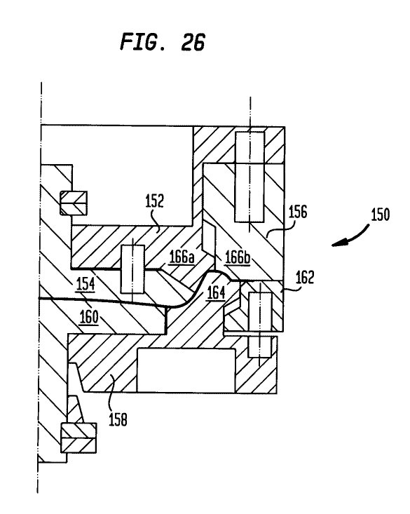

In FIG. 25, a still more advanced stage, the die set is forming the container. In FIG. 26, the die set is fully closed and the contour portion of the punch base applies pressure to the flange area.

The die opens by reversed staging and a fully formed product is removed from the die set. Utilizing the procedures noted above a series of plates were prepared having the shape of Profile 1 described in detail above. These plates were formed with conventional board and with nano starch impregnated board as described earlier. Results appear in Tables 8 and 9 below.

TABLE 8
Pilot Plant Plate Properties

| | Basis | | Starch | Dry | Wet | | | | | Load to |
|---|---|---|---|---|---|---|---|---|---|---|
| | Weight | Caliper | Weight | Plate | Plate | Rim | Taber | Tensile | | Failure, |
| Starch | lbs/rm | mils | lbs/rm | Rigidity | Rigidity | Stiffness | gm | psi/1000 | ZDT | lbs |
| Control | 225 | 21 | 12 | 300 | 230 | 1508 | 239 | 327 | 41 | 3.25 |
| Nano 1 | 227 | 22 | 23 | 375 | 114 | 2220 | 266 | 338 | 51 | 3.50 |
| Nano 2 | 221 | 22 | 16 | 295 | 92 | 1710 | 261 | 328 | 46 | 3.00 |

TABLE 9
Commercial Trial Plate Properties

| | | | | | 1 Hand Hold | |
|---|---|---|---|---|---|---|
| | Basis | | | Rim | Maximum - | Wet Rigidity |
| | Weight | Caliper | Rigidity | Stiffness | Dry Weight | Water |
| Description | (lbs/ream) | (mils) | (grams/.5″) | (grams/.1″) | (lbs) | (grams/.5″) |
| 245# Control Starch - | 252 | 23.8 | 540 | 2219 | 4.08 | 255 |
| Trial Shape 9-12 lbs/rm | | | | | | |
| Dixie 240# Nano | 250 | 21.5 | 671 | 2448 | 5.00 | 186 |
| Strach - Trial Shape | | | | | | |

It is seen in Tables 8 and 9 that the plates impregnated with greater than 20 lbs of nano starch per 3000 ft² ream exhibited surprising (dry) rigidity, much more so than one would expect based on the differences in Taber stiffness and tensile strength.

There is thus provided in accordance with the present invention a disposable servingware container press-formed from a generally planar paperboard blank including: (a) a bottom panel; (b) a first annular transition portion extending upwardly and outwardly from the bottom panel defining a first radius of curvature; (c) an optional sidewall portion extending upwardly and outwardly from the first annular transition portion; (d) a second annular transition portion flaring outwardly with respect to the first annular transition portion; and (e) an outer flange portion as described above. Generally, the nano starch exhibits a characteristic particle size range of from 50 nanometers to 100 microns and a weight average particle size between 75 nanometers and 1 micron. The nano starch generally has a surface area of greater than 100 m²/g and typically a surface area of greater than 200 m²/g. The nano starch may have a surface area of greater than 100 m²/g up to 1000 m²/g. Typical properties of the starch include a Brookfield viscosity of less than 700 cps at 140° F. and 30% concentration in water, such as a Brookfield viscosity of between 20 cps and 700 cps in water at 140° F. and 30% concentration in water.

The nano starch may be added in amounts greater than 22 lbs per 3000 ft² ream or greater than 22.5 or 25 lbs per 3000 ft² ream if so desired. Typically, the paperboard blank is sized with nano starch in an amount of greater than 20 lbs per 3000 ft² ream up to 50 lbs per 3000 ft² ream and the nano starch exhibits a surface penetration of greater than 9 mils into the paperboard. The surface penetration of the nano starch may be greater than 10 mils or greater than 12 mils in some embodiments. A surface penetration of greater than 9 mils into the paperboard up to 15 mils into the paperboard is somewhat typical as is a starch layer concentration of greater than 1.7 lbs/ream/mil. In some cases, the nano starch side exhibits a starch layer concentration of greater than 1.75 lbs/ream/mil, such as greater than 1.85 lbs/ream/mil, or greater than 2 lbs/ream/mil, or greater than 2.5 lbs/ream/mil. In most cases, the nano starch side exhibits a starch layer concentration of from greater than 1.7 lbs/ream/mil up to 3 lbs/ream/mil. While it is possible to size only one side of the paper stock, typically, both sides of the paperboard are sized with nano starch.

Various board weights may be used, generally, the paperboard blank has a basis weight from 80 lbs/3000 ft² ream to 400 lbs/3000 ft² ream, such as from 90 lbs/3000 ft² ream to 300 lbs/3000 ft² ream in most cases. Typically, the paperboard blank has a basis weight of more than 150 lbs/3000 ft² ream and in many cases the paperboard blank has a basis weight of more than 200 lbs/3000 ft² ream.

In another aspect of the invention, there is provided a method of making a disposable servingware container including: (a) disposing a generally planar paperboard blank sized with nano starch in an amount greater than 20 lbs/3000 ft² ream in a forming apparatus, which apparatus has a punch and die mounted for reciprocal motion with respect to each other; and (b) forming the generally planar paperboard blank under heat and pressure between the punch and die into a container having the characteristics noted above. In a preferred embodiment, the paperboard blank is a scored paperboard blank, with about 20 to about 100 radially extending scores in most cases.

In still another aspect of the invention, there is provided a method of making a disposable servingware container comprising: (a) sizing paperboard stock with nano starch in an amount greater than 20 lbs per 3000 ft² ream; and (b) cutting the paperboard stock into paperboard blanks; (c) disposing a generally planar paperboard blank sized with nano starch in an amount greater than 20 lbs/3000 ft² ream in a forming apparatus, which apparatus includes a punch and die mounted for reciprocal motion with respect to each other; and (d) forming the generally planar paperboard blank under heat and pressure between the punch and die into a container having the characteristics noted above.

In typical embodiments, the paperboard stock is sized with an aqueous dispersion of nano starch having a concentration of at least 20% by weight nano starch, such as a concentration of at least 22.5% by weight nano starch or a concentration of at least 25% by weight nano starch. Generally, the paperboard stock is sized with an aqueous dispersion of nano starch having a concentration of from about 15% to about 30% by weight nano starch and the starch as well as sizing conditions are selected such that the dispersion exhibits a Brookfield viscosity of less than 700 cps under sizing conditions less than 250 cps is preferred. Typical viscosity values of the nano starch dispersion may be between 20 and 70 cps under sizing conditions.

While the invention has been described in connection with numerous examples, it will be appreciated by one of skill in the art that plates, bowls, oval platters and trays and so forth having various shapes and sizes may be made from paperboard with relatively high nano starch content. Some may be square or rectangular with rounded corners, triangular, multi-sided, polygonal and similar shape having the profile as described. The products may be compartmented. So also, instead of using a single paperboard layer blank, a composite paperboard blank may be used. For example, a container 10 of the invention may be formed from a composite paperboard material wherein the containers are formed by laminating three separate paperboard layers to one another in the form of the container having the shape shown in FIG. 15A. The particular manipulative steps of forming a composite plate are discussed in greater detail in U.S. Pat. Nos. 6,039,682, 6,186,394 and 6,287,247, the disclosures of which are incorporated herein by reference. Containers of the invention thus provide for increases in Rigidity, Rim Stiffness, as well as an improved ability to support a load. Modifications to the specific embodiments described above, within the spirit and scope of the present invention as is set forth in the appended claims, will be readily apparent to those of skill in the art.

What is claimed is:

1. A disposable servingware container press-formed from a generally planar paperboard blank comprising:
(a) a bottom panel;
(b) a first annular transition portion extending upwardly and outwardly from the bottom panel defining a first radius of curvature;
(c) an optional sidewall portion extending upwardly and outwardly from the first annular transition portion;
(d) a second annular transition portion flaring outwardly with respect to the first annular transition portion; and
(e) an outer flange portion extending outwardly with respect to the second annular transition portion, wherein the paperboard blank is sized with nano starch in an amount of greater than 20 lbs per 3000 ft² ream.

2. The disposable servingware container according to claim 1, wherein the nano starch exhibits a characteristic particle size range of from 50 nanometers to 100 microns.

3. The disposable servingware container according to claim 1, wherein the nano starch exhibits a weight average particle size between 75 nanometers and 1 micron.

4. The disposable servingware container according to claim 1, wherein the nano starch has a surface area of greater than 100 m²/g.

5. The disposable servingware container according to claim 1, wherein the nano starch has a surface area of greater than 200 m²/g.

6. The disposable servingware container according to claim 1, wherein the nano starch has a surface area of greater than 100 m²/g up to 1000 m²/g.

7. The disposable servingware container according to claim 1, wherein the nano starch is a crosslinked starch.

8. The disposable servingware container according to claim 1, wherein the nano starch is a cationic starch.

9. The disposable servingware container according to claim 1, wherein the nano starch exhibits a Brookfield viscosity of less than 700 cps at 140° F. and 30% concentration in water.

10. The disposable servingware container according to claim 1, wherein the nano starch exhibits a Brookfield viscosity of between 20 cps and 700 cps in water at 140° F. and 30% concentration in water.

11. The disposable servingware container according to claim 1, wherein the paperboard blank is sized with nano starch in an amount of greater than 22 lbs per 3000 ft² ream.

12. The disposable servingware container according to claim 1, wherein the paperboard blank is sized with nano starch in an amount of greater than 25 lbs per 3000 ft² ream.

13. The disposable servingware container according to claim 1, wherein the paperboard blank is sized with nano starch in an amount of greater than 20 lbs per 3000 ft² ream up to 50 lbs per 3000 ft² ream.

14. The disposable servingware container according to claim 1, wherein the nano starch exhibits a surface penetration of greater than 9 mils into the paperboard.

15. The disposable servingware container according to claim 1, wherein the nano starch exhibits a surface penetration of greater than 9 mils into the paperboard up to 15 mils into the paperboard.

16. The disposable servingware container according to claim 1, wherein the nano starch side exhibits a starch layer concentration of greater than 1.7 lbs/ream/mil.

17. The disposable servingware container according to claim 1, wherein the nano starch side exhibits a starch layer concentration of greater than 1.75 lbs/ream/mil.

18. The disposable servingware container according to claim 1, wherein the nano starch side exhibits a starch layer concentration of greater than 1.85 lbs/ream/mil.

19. The disposable servingware container according to claim 1, wherein the nano starch side exhibits a starch layer concentration of greater than 2 lbs/ream/mil.

20. The disposable servingware container according to claim 1, wherein the nano starch side exhibits a starch layer concentration of greater than 2.5 lbs/ream/mil.

21. The disposable servingware container according to claim 1, wherein the nano starch side exhibits a starch layer concentration of from greater than 1.7 lbs/ream/mil up to 3 lbs/ream/mil.

22. The disposable servingware container according to claim 1, wherein both sides of the paperboard are sized with nano starch.

23. The disposable servingware container according to claim 1, wherein the paperboard blank has a basis weight from 80 lbs/3000 ft² ream to 400 lbs/3000 ft² ream.

24. The disposable servingware container according to claim 1, wherein the paperboard blank has a basis weight from 90 lbs/3000 ft² ream to 300 lbs/3000 ft² ream.

25. The disposable servingware container according to claim 1, wherein the paperboard blank has a basis weight of more than 150 lbs/3000 ft² ream.

26. The disposable servingware container according to claim 1, wherein the paperboard blank has a basis weight of more than 200 lbs/3000 ft² ream.

27. A disposable servingware container press-formed from a generally planar paperboard blank comprising:
(a) a bottom panel;
(b) a first annular transition portion extending upwardly and outwardly from the bottom panel defining a first radius of curvature;
(c) an optional sidewall portion extending upwardly and outwardly from the first annular transition portion;
(d) a second annular transition portion flaring outwardly with respect to the first annular transition portion; and
(e) an outer flange portion extending outwardly with respect to the second annular transition portion, wherein the paperboard blank is sized with nano starch which exhibits a starch layer concentration of greater than 1.7 lbs/ream/mil.

28. The disposable servingware container according to claim 27, wherein the nano starch sizing exhibits a starch layer concentration of greater than 1.75 lbs/ream/mil.

29. The disposable servingware container according to claim 27, wherein the nano starch sizing exhibits a starch layer concentration of greater than 1.85 lbs/ream/mil.

30. The disposable servingware container according to claim 27, wherein the nano starch sizing exhibits a starch layer concentration of greater than 2 lbs/ream/mil.

31. The disposable servingware container according to claim 27, wherein the nano starch sizing exhibits a starch layer concentration of greater than 2.5 lbs/ream/mil.

32. The disposable servingware container according to claim 27, wherein the nano starch sizing exhibits a starch layer concentration of from greater than 1.7 lbs/ream/mil up to 3 lbs/ream/mil.

33. The disposable servingware container according to claim 27, wherein the nano starch sizing exhibits a surface penetration of greater than 9 mils into the paperboard.

34. The disposable servingware container according to claim 27, wherein the nano starch sizing exhibits a surface penetration of greater than 10 mils into the paperboard.

35. The disposable servingware container according to claim 27, wherein the nano starch sizing exhibits a surface penetration of greater than 12 mils into the paperboard.

36. The disposable servingware container according to claim 27, wherein the nano starch sizing exhibits a surface penetration greater than 9 mils into the paperboard up to about 15 mils into the paperboard.

37. The disposable servingware container according to claim 27, wherein both sides of the paperboard blank are sized with nano starch.

38. A method of making a disposable servingware container comprising:
(a) disposing a generally planar paperboard blank sized with nano starch in an amount greater than 20 lbs/3000 ft² ream in a forming apparatus, which apparatus includes a punch and die mounted for reciprocal motion with respect to each other; and
(b) forming the generally planar paperboard blank under heat and pressure between the punch and die into a container including:
(i) a bottom panel;
(ii) a first annular transition portion extending upwardly and outwardly from the bottom panel defining a first radius of curvature;
(iii) an optional sidewall portion extending upwardly and outwardly from the first annular transition portion;
(iv) a second annular transition portion flaring outwardly with respect to the first annular transition portion; and
(v) an outer flange portion extending outwardly with respect to the second annular transition portion.

39. The method according to claim 38, wherein the paperboard blank is a scored paperboard blank.

40. The method according to claim 38, wherein the paperboard blank has from about 20 to about 100 radially extending scores.

41. The method according to claim 38, wherein the paperboard blank is sized with greater than 22.5 lbs of nano starch per 3000 ft² ream.

42. The method according to claim 38, wherein the paperboard blank is sized with greater than 25 lbs of nano starch per 3000 ft² ream.

43. A method of making a disposable servingware container comprising:
(a) sizing paperboard stock with nano starch in an amount greater than 20 lbs per 3000 ft² ream; and
(b) cutting the paperboard stock into paperboard blanks;
(c) disposing a generally planar paperboard blank sized with nano starch in an amount greater than 20 lbs/3000 ft² ream in a forming apparatus, which apparatus includes a punch and die mounted for reciprocal motion with respect to each other; and
(d) forming the generally planar paperboard blank under heat and pressure between the punch and die into a container including:
(i) a bottom panel;
(ii) a first annular transition portion extending upwardly and outwardly from the bottom panel defining a first radius of curvature;
(iii) an optional sidewall portion extending upwardly and outwardly from the first annular transition portion;
(iv) a second annular transition portion flaring outwardly with respect to the first annular transition portion; and
(v) an outer flange portion extending outwardly with respect to the second annular transition portion.

44. The method according to claim 43, wherein the paperboard stock is sized with an aqueous dispersion of nano starch having a concentration of at least 20% by weight nano starch.

45. The method according to claim 43, wherein the paperboard stock is sized with an aqueous dispersion of nano starch having a concentration of at least 22.5% by weight nano starch.

46. The method according to claim 43, wherein the paperboard stock is sized with an aqueous dispersion of nano starch having a concentration of at least 25% by weight nano starch.

47. The method according to claim 43, wherein the paperboard stock is sized with an aqueous dispersion of nano starch having a concentration of from about 15% to about 30% by weight nano starch.

48. The method according to claim 43, wherein the paperboard stack is sized with an aqueous dispersion of nano starch which exhibits a Brookfield viscosity of less than 700 cps under sizing conditions.

49. The method according to claim 43, wherein the paperboard stack is sized with an aqueous dispersion of nano starch which exhibits a Brookfield viscosity of less than 250 cps under sizing conditions.

50. The method according to claim 43, wherein the paperboard stack is sized with an aqueous dispersion of nano starch which exhibits a Brookfield viscosity of between 20 and 700 cps under sizing conditions.
